(19) United States
(12) Patent Application Publication
(10) Pub. No.: US 2003/0200139 A1
(43) Pub. Date: Oct. 23, 2003

(54) Method of marketing a service industry and tracking individuals referred to the service industry by a host website

(76) Inventor: Qiping Yan, Reno, NV (US)

Correspondence Address: Michael W. Starkweather, Jones, Waldo, Holbrook & McDonough, Suite 1500, 170 South Main Street, Salt Lake City, UT, 84101, US

(21) Appl. No.: 10/124,144

(22) Filed: Apr. 17, 2002

(51) Int. Cl. G06F 17/60

(52) U.S. Cl. 705/14

(57) ABSTRACT

There is provided a method of marketing a service industry and tracking individuals referred to a service industry by a host website. The method includes the step of establishing a database, that is accessible through the host website, that includes an incentive for visiting the service industry; and optionally, information about the service industry. A membership card is provided to the individual, and the incentive is redeemed when the individual visits the service industry and presents the membership card. Each presentation of the membership card is recorded, thereby tracking the individuals referred to the service industry by the host website.

### FIELD OF THE INVENTION

The present invention relates generally to a method of marketing a service industry and tracking individuals referred to the service industry by a host website.

### BACKGROUND

In a service industry, such as a restaurant, the world-wide web is a valuable medium for marketing one's services. Millions of service industry businesses now utilize web-based advertising to reach greater audiences and offer their services. Different types of web-based advertisements include home webpages dedicated to a particular business, and collections of related businesses grouped together, which can be individually accessed through a host website. An example of a collection of related businesses grouped together through a host website is http://www.usdiners.com.

An advantage of advertising through a host website, is that it allows a user searching for a particular good or service to go to a single website and compare the individual dealers of those goods or services. From the dealer's point of view, such advertising is advantages because 1) it increases the business's overall name exposure, and 2) it provides individuals who are desirous to purchase the business's particular goods/services an opportunity to view its marketing materials.

However, as with any advertising expenditure, the costs associated with web-based advertising must be justified by increased revenues generated as a result of those expenditures. If a web-based advertisement is not generating any additional business, it would not be a worthwhile expenditure.

For example, in the context of a restaurant advertising through a host website, these sites are currently able to identify how many individuals visit their site. However, none are presently capable of tracking the number of individuals that visit their site, and consequently visit one of the restaurants advertising thereon. Therefore, the restaurant owner is unable to tell how many people actually ate at the restaurant as a result of advertising materials on the host website.

Therefore, a feedback system that could notify businesses that their web-based advertising is being seen, and resulting in additional customers, would be valuable.

Additionally, service industry marketing methods are presently not well-suited for accommodating immediate business circumstances. For example, in the restaurant industry, some examples of marketing methods include television advertisements, radio advertisements, printed advertisements, mailed advertisements, and home webpages. While each of these methods of marketing are effective in unique ways, none is capable of responding to immediate business circumstances.

To illustrate, in a restaurant, a variety of factors, including weather, quality of nearby entertainment, and economic factors, contribute to whether customers will patronize the restaurant on a given day. As such, a business may experience significant slowdown on a particular day if any of these circumstances are unfavorable. Conventional marketing campaigns to boost business on slow days would not be feasible. For example, it would take weeks or even months to prepare a printed advertisement or home webpage. Television and radio advertisements would take even longer.

Therefore, a marketing system for a service industry that allows the service industry to immediately and easily update and issue its marketing information would be desirable.

The following U.S. patents and published U.S. patent applications are deemed generally pertinent to the present invention:

U.S. patent application No. 20010011235 to Kim, Ki Yeol, et al.

This reference discloses an apparatus for realizing personal shops in electronic commerce business. It is an object of the present invention to provide an apparatus for realizing personal shops in an electronic commerce business, which enables users to use shopping malls easily and conveniently by presenting contents screens fit for the member specialties by members and recommending goods suitable for the purchase pattern of the users. Further according to the present invention, the apparatus for realizing personal shops in electronic commerce business comprises foods management unit for managing goods information; a web server for providing a member registration web page to connected users, receiving users information from the users upon the member registration if the users are initiated to a membership, provides shopping malls if the users who are registered as members are logged-in, generating data from all materials during the use of the shopping malls by providing the shopping malls if the user who are registered as members, receiving goods data from the goods management unit by using analyzed customers tendency data if the users are logged-in again, and realizing and providing a unique personal shop screen to each user; a members management unit for databasing the users information from the web server and the itemized materials inputted during the use of the shopping malls with the users logged-in; and a customers information analysis unit for providing customers information, goods information, order and delivery information, customers navigation information, and so on from the members management unit, systematically processing the information, and providing to the web server the processed information of goods purchase forecast values by customers, goods interest degrees by customers, goods purchase degrees by customers, and so on.

U.S. patent application No. 20010034635 to Winters, Gil

This reference discloses a fully integrated, on-line digital collectible award redemption and instant-win program. Consumers will receive Limited Edition Digital Objects (LEDOs) from online merchants and websites as a premium for making online purchases, visiting their websites, or doing other activities such as taking surveys, signing up for memberships, etc. LEDOs will be represented on users' computer and TV screens as small images that can be collected and organized in an on-screen viewing album. When activated, LEDOs can show pictures, play sounds and movies, and be used for a variety of interactive entertainment, including instant win contests, and as game pieces for video and online games. As for any collectible, key to the appeal of LEDOs is that they are organized into lines of content that appeals to the passions, interests, and lifestyles of consumers. Utilizing the present invention, LEDOs can also be saved as redemption points, and can be traded in for redemption award. Consumers as well as on-line websites will be able to recruit new users of LEDOs, and will be compensated for their recruiting efforts on an ongoing basis relative to the number of new LEDOs their recruits acquire. This compensation can take the form of monetary awards or the award of additional LEDOs. In addition, a central data processing system, accessed through “online” networks of computers, will provide consumers with a “shopping portal” to find goods and services available at participating merchants and websites that will in award LEDOs to users in return, a catalog showroom of redemption merchandise, and the ability to interact with other LEDO collectors in games, chat, auctions, and trading.

U.S. patent application No. 20010037253 to Kensev, Lanard M.

This reference discloses a secure format system for carrying out on-line purchasing of products and includes on-line shopping and customer service portals and merchant and customer members. Each portal and each merchant member website are identified by respective domain names having the same format, such being (prefix)(name).(suffix), and having a (prefix) portion, a (name) portion and a (suffix) portion. The merchant member websites are accessible via the shopping portal and the (prefix) portions of their domain names are the same as the (prefix) portion of the domain names of the shopping portal. The (prefix) portion of the domain name of the on-line customer service portal is the same as the (prefix) portions of the domain names of the shopping portal and merchant member websites. The customer members provide their personal and financial information to the customer service portal and visit the shopping portal on-line in order to go to any of the websites of the merchant members to browse their products and select products to purchase and when completed to cause processing of purchase transactions from each of the merchant members of the particular purchased products to be handled by the customer service portal such that the merchant members only receive shipping address information from the customer service portal of the locations of the customer members for delivery of the purchased products thereto.

U.S. patent application No. 20010037263 to Hirota, Tomoyuki et al.

This reference discloses an electronic (e-) commerce support system. The system has a Web server to which each retailer makes an access via a terminal of each retailer over a network, thus performing access management for each retailer. The system also has a database for storing data for each of the functions required for e-commerce. It also has an application server to establish each of the functions by using the stored data and necessary functions among the functions required for e-commerce being offered to each retailer and available through the terminal of each retailer over the network.

U.S. Pat. No. 6,260,019 to Courts

This reference discloses a method and apparatus for facilitating electronic commerce between suppliers of predictions and consumers of predictions. Suppliers provide their predictions on the outcomes of future events in one or more categories, and each supplier's accuracy is tracked. Consumers interested in obtaining predictions for one of more of those categories are allowed to selectively choose which suppliers' predictions they wish to view. The suppliers are compensated based on the number of consumers who view their predictions. In one embodiment, the consumers pay for the predictions that they view while the suppliers are paid a portion of the revenue obtained from the consumers. In another embodiment the consumers are not charged and all revenue is derived from advertisers. The system in accordance with the present invention includes a controller which automatically credits each supplier's account, aggregates earnings for that supplier, and automatically sends an electronic pay order to the Federal Reserve's automated clearinghouse to thereby facilitate payment.

U.S. Pat. No. 6,026,376 to Kenney

This reference discloses an interactive electronic shopping system and method to create a virtual shopping facility from an actual shopping facility, such as a grocery store, restaurant, or office. A shopper at a computer or other suitable display device can move through the virtual shopping facility and see replicas of what would be seen in moving through the actual shopping facility. Various lists of items selected for purchase can be made, and predetermined lists and information can be displayed. Changes in the actual shopping facility, such as a change in a display of goods, can be accommodated by replacing prior data with new data so that the virtual shopping environment is kept current with the actual shopping facility.

U.S. Pat. No. 5,987,421 to Chuang

This reference discloses a state of the art technological system composed of computers and local area radio network technologies to allow visitors to an amusement park or similar facility to electronically register for positions within a line for those popular rides, attractions and restaurants thereby eliminating the physically tiring wait in the actual lines. The system also allows park visitors to search for the location, distance and direction within the park boundaries of all other members within the same group at any given time. The invention includes a computer system as a main control, a number of specialized communication modules at appropriate locations and a larger number of movable visitor ID devices operating in a custom designed method to provide the above mentioned services. The system is simple to use and can be fully automated thereby reducing the manpower necessary to otherwise run the park.

U.S. patent application No. 20010047301 to Walker, Jay S.; et al.

This reference discloses system wherein a price associated with a menu item is automatically determined based at least partly on revenue management information. A request for a menu is received and a menu, including the automatically determined price, is generated in response to the request.

U.S. patent application No. 20010029459 to Fujiwara, Yasuhisa

This reference discloses an invention which relates to a travel information center which provides travel information upon a user request. In order to confirm the user is a registered user, a controller will require a search of a memory database, located in the travel information center, and confirm the users identification number entered by the user. Upon confirmation, the member can access the travel information center. The user is now able to input starting and ending locations for their course of travel. The travel information center will then provide information such as the shortest or quickest route to arrive at the desired destination. Other information can be obtained by the user through the travel information center that will be useful to the members along the travel route, such as shopping malls and restaurant locations.

U.S. Pat. No. 6,289,348 to Richards et al.

This reference discloses a group organizational system operational as a computer program on a computer network. The computer network provides communication between a host server and a plurality of remote individual users. The group organizational system includes an organization database, a registrant database and a roster database. The organization database includes information relevant to an organization and predetermined registration qualifications. The registrant database is in communication with the remote users and the host server. The registrant database receives registration information from the remote users. The roster database is in communication with the host server. The host server includes a registration generation program for comparing the registration information of the remote users with the predetermined registration qualifications to determine whether a remote user qualifies as member of the organization. The host server further includes a roster generation program for generating a plurality of rosters including the members of the organization, based upon the registration information of the members of the organization. The group organizational system can further include a schedule database which is in communication with the host server. A schedule generation program for generating a schedule of events of the organization based upon the rosters and predetermined scheduling restraints. The group organizational system further includes a product database. The product database comprising product information about products relevant to the organization. A product generation program which generates a product list based upon the registration information of the remote users and the product information of the product database.

U.S. patent application No. 20010042007 to Klingle, David B.

This reference discloses a method, system and computer program component for allowing the controlled use of automated ancillary service facilities. Example ancillary service facilities include a car wash, automobile a vacuum cleaner and a compressed air dispenser. A provider of ancillary services associates credits with either a certificate that is given to a customer, or with an identification of the customer himself or herself. The customer presents the certificate or identification to automated reading equipment at the ancillary service facility and is allowed to use the facility if a credit has been associated with the presented item.

U.S. Pat. No. 5,056,019 to Schultz, et al.

This reference discloses a marketing method for providing manufacturer purchase reward offers by automatically tracking the purchases of member consumers through the use of bar-coded membership cards and using the purchase records in a data processing system to determine if the required purchases have been made to earn a reward. Each member consumer receives a reward booklet disclosing the available reward offers, a periodic status report indicating the member consumer's progress toward earning rewards, and a reward certificate for those rewards earned.

U.S. Pat. No. 5,924,080 to Johnson

This reference discloses a method of processing merchandise discounts by providing a computerized membership system. At least one provider's computer has a database for the storage and retrieval of information. The database stores demographic information regarding merchants, manufacturers, and consumers in predetermined files. A communication system, such as a cash register, provides real time communication between members and the provider's computer. The consumer and merchandise identification codes are stored in the database, including the identification code of merchandise subject to a price discount. Discounted merchandise is displayed through media advertisement and/or notification proximate the merchandise. The consumer selects merchandise to purchase. The consumer membership card, containing the consumer's identification, and product code of the merchandise is scanned. The merchandise identification code is scanned and compared with the stored product identification codes of the discounted merchandise. The discounts are deducted and a slip printed. The merchandise and consumer information is sorted and stored in the database. The data is compiled and reports are generated when providing purchasing demographics using the data stored in the demographics database.

U.S. Pat. No. 6,021,406 to Kuznetsov

This reference discloses a method for storing map data in a database and a method of searching the database to find objects in a given area and to find objects nearest to a location. To generate the map data, a map plane is divided into a number of squares and the squares are numbered with spatial key numbers according to a space filling curve. Objects identifying places such as restaurants or hotels are placed in a main table of the database along with one of the spatial keys (object keys) intersecting an area of the map occupied by the object. A secondary table of the database is then created with one column including object keys corresponding to the main table, and other columns identifying ranges of spatial keys for objects identified by the object keys. To search the database to find objects in a given area, ranges of spatial keys are calculated for the given area and compared with ranges in the secondary table to identify object keys. The object keys identified are then used to obtain the desired objects from the main table.

Each of these patents is hereby incorporated by reference for its supporting teachings.

While each of the foregoing patents demonstrates improvement in its respective field, none of these references teach a marketing system for a service industry that allows the service industry to immediately and easily update and issue its marketing information. Nor do they teach a method of tracking individuals referred to the service industry by a host website.

### SUMMARY OF THE INVENTION

There is, therefore, provided a method of tracking individuals referred to the service industry by a host website. The method includes the step of establishing a database, that is accessible through the host website, that includes an incentive for visiting the service industry; and optionally, information about the service industry. A membership card is provided to the individual, and the incentive is redeemed when the individual visits the service industry and presents the membership card. Each presentation of the membership card is recorded, thereby tracking the individuals referred to the service industry by the host website.

One embodiment includes is the additional step of providing an interface to the service industry that allows the service industry to remotely update the incentives. In one embodiment, the service industry is a restaurant. In one embodiment, the membership card is incorporated into a credit card.

There is also provided a method of marketing a service industry. The method includes the step of establishing a database, that is accessible through the host website, that includes an incentive for visiting the service industry, and optionally, information about the service industry. Next, an interface is provided to the service industry that allows the service industry to remotely update the incentives, responsive to present business circumstances.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a depiction of the opening page on the host website according to the present invention.

FIG. 2 is a depiction of an account management security page.

FIG. 3 is a depiction of an account management page.

FIG. 4 is a depiction of an online member incentive creation page.

FIG. 5 is a depiction of a membership card.

FIG. 6 is a depiction of a restaurant search results list.

FIG. 7 is a depiction of a member incentive page.

FIG. 8 is a depiction of an online menu page.

### DETAILED DESCRIPTION OF THE PREFERRED EMBODIMENT(S)

The presently preferred embodiments of the invention will be best understood by reference to the drawings, wherein like parts are designated with like numerals throughout. It is initially noted that the present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

Initially a host will compile a database of restaurants that is accessible through a host website. The restaurants in the database are categorized by cuisine type, by restaurant name, and by location. In the present embodiment, the host compiles the database of restaurants from regional directories, such as telephone listings. Inclusion in the database therefore requires no active part by restaurateurs. However, if a restaurant wishes to become a subscribing restaurant, it will need to take an active part in the subscription process (e.g. the restaurant pays a periodic fee to be included in the database, or the subscription could be free, but requires the restaurant to provide information about itself to the host). It is noted that, in another embodiment of the present method, only subscribing restaurants are included in the database.

In either case, particular marketing benefits will be offered to subscribing restaurants. Specifically, the restaurants that have subscribed to the host's database may include marketing information about their restaurant on the database. For example, a subscribing restaurant could import into the database information such as menus, maps and gift certificate purchase orders. More importantly, a subscribing restaurant may issue a member incentive that is imported into the database.

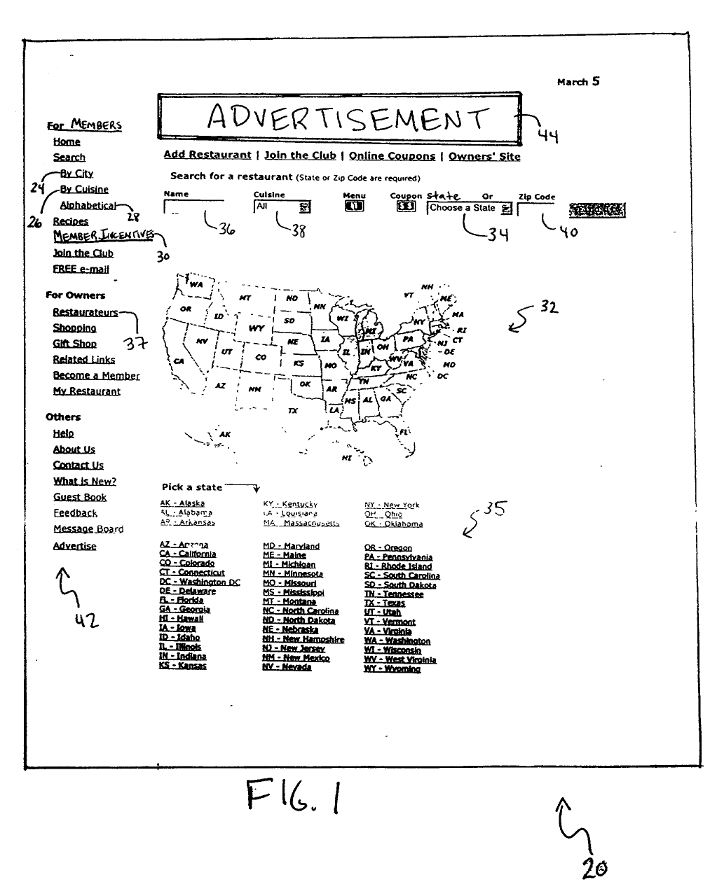

FIGS. 1-5 illustrate the process by which a subscribing restaurant issues a member incentive in one embodiment of the present invention. FIG. 1 shows an example of an opening page 20 of the host website according to the present invention. The opening page 20 is the interface between a user, for example the subscribing restaurant owner, and the database of restaurants. The opening page 20 can also include links to a variety of category-specific search pages.

For example, if a user were to mouse click on link 24, he would be directed to a city-based search page. If a user were to click on link 26, he would be directed to cuisine-based search page. Similarly, link 30 allows a user to conduct a search based on member incentives listed in the database.

In this embodiment, an electronic map of the United States 32 and other state specific links 35 direct a user to a state-based search page. Drop-down boxes can be used to specify the state 38 or cuisine type 34 to be searched. The database can also be searched by restaurants in a particular zip code 40 or by restaurant name 36.

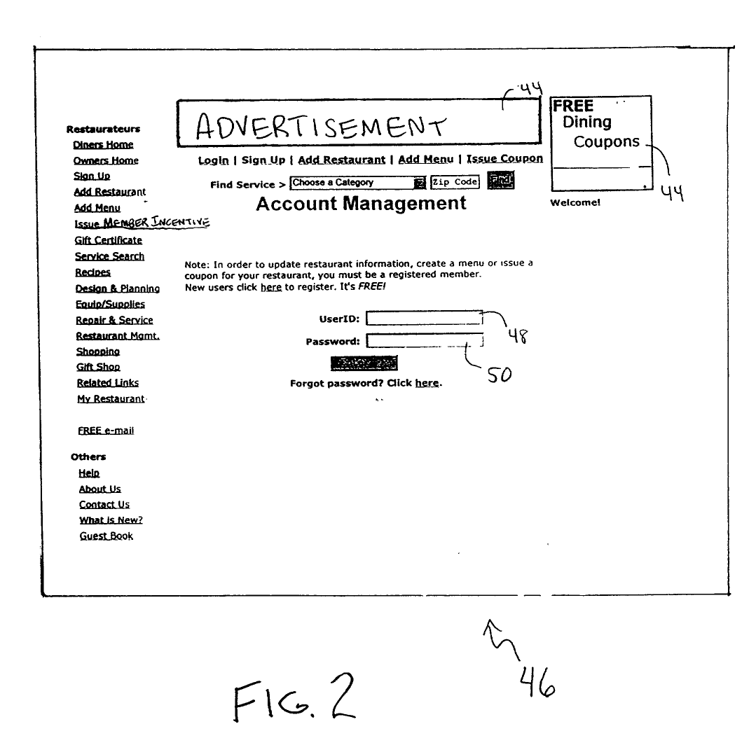

When issuing a member-incentive, the subscribing restaurant owner, or other individual acting on behalf of the subscribing restaurant, would click on the restaurateurs link 37. The individual would then be directed to an account management security page 46 as shown in FIG. 2.

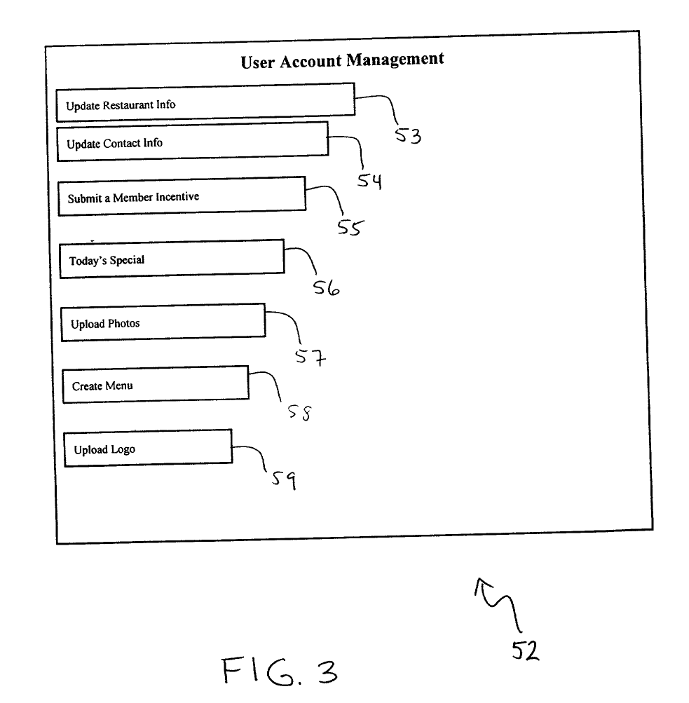

Once at the account management security page 46, the individual would need to provide a user identification code 48 and a password 50 that is provided upon subscription. Once the correct user identification code 48 and password 50 is entered, the individual is then directed to a user account management page 52, shown in FIG. 3.

The user account management page 52 includes a number of electronic buttons that allow the individual to edit and update restaurant information on the database. For example, button 53 links the individual to a page that allows him to update his restaurant information on the database. Button 54 links an individual to a page that allows him to update contact information. Button 56 links an individual to a page that allows him to update daily specials. Button 57 links an individual to a page that allows him to upload photos. Button 58 links an individual to a page that allows him to create and edit a menu. Button 59 links an individual to a page that allows him to upload the restaurant's logo, such that it may be included with the subscribing restaurant's database marketing materials. Button 55 links an individual to a page that allows him to submit a member incentive onto the database.

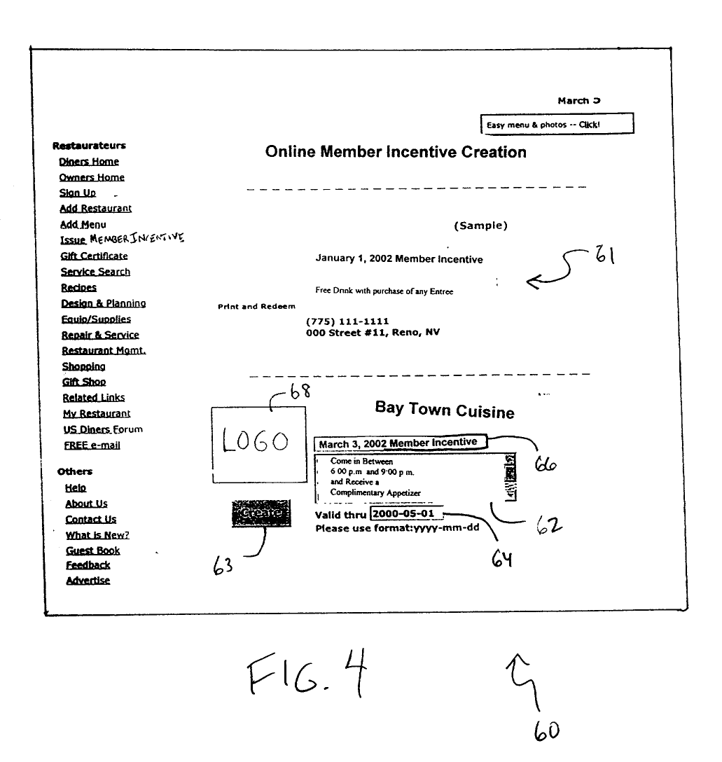

FIG. 4 is an example of an online member incentive creation page 60 that would be displayed when a user clicked on button 55 (FIG. 3). The online member incentive creation page 60 has a dialogue box 62 that allows the owner to enter its member incentive. Dialogue box 64 allows the offer expiration date to be specified, and box 66 allows the date of the offer to be specified. In this embodiment, a sample member incentive 61 is shown on the page 60. Once this information is entered, the incentive is imported into the database by hitting the “Create” button 63.

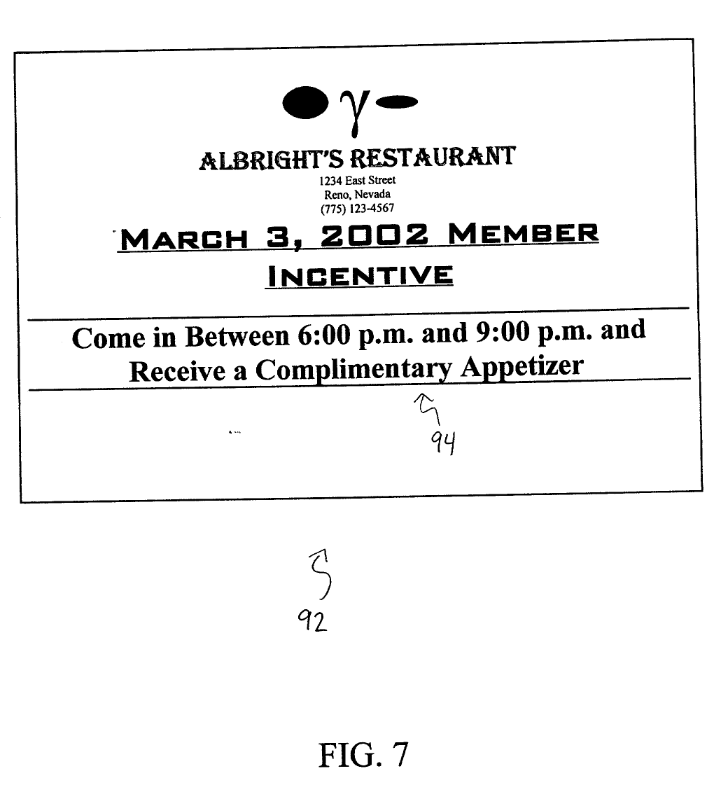

An important element of the present invention is that the subscribing restaurant is, through the host website, able to remotely update its incentives 94. This can be particularly advantageous for a subscribing restaurant who wishes to post time-sensitive member incentives 94. For example, as shown in FIG. 7, a restaurant owner/manager could, under the present invention, have a host or hostess access the database from a computer at the restaurant having internet access. The host/hostess could then upload an incentive 94 onto the database for members who visit the restaurant between certain hours.

Consequently, a subscribing restaurant could adjust its offers to accommodate either a slow night or a busy night. For example, when the restaurant is busy, it may not be as desirable to entice clientele to the restaurant because the wait may create a negative impression. Alternatively, if the restaurant is slow, a generous member incentive 94 may entice customers who would otherwise not have patronized the restaurant that night.

In this manner, a subscribing restaurant is able to immediately import its marketing information, and particularly its member incentives 94, into the existing database. Once this information is in the database, it can then be accessed and utilized by members.

Once members are apprised of the incentives 94, they can then redeem those incentives 94 by presentation of their membership cards 70 at the subscribing restaurants. FIGS. 1, 5-7 illustrate how members are able to access and utilize the information on the database, and then redeem those incentives via membership cards 70.

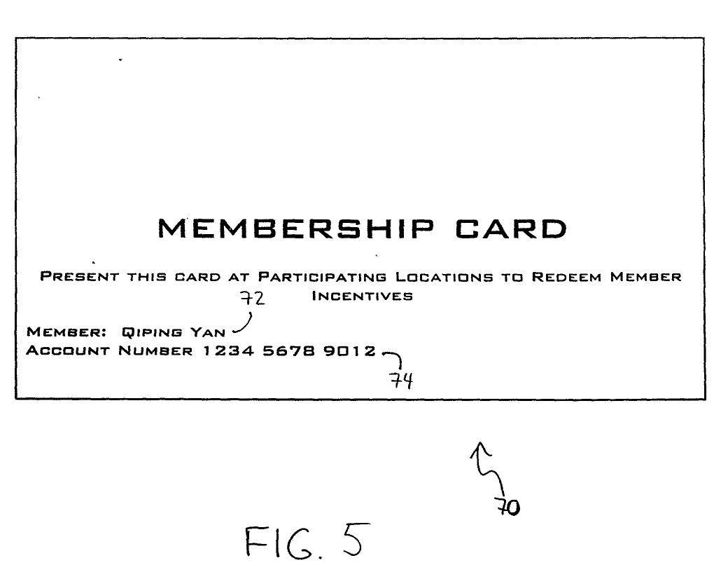

FIG. 5 is an example of a membership card 70 that would be suitable for the use with the present invention. The membership card 70 can include information about the member such as his or her name 72, and the membership account number 74. The membership card 70 may also include a picture of the member. In other embodiments, the membership card 70 is incorporated into a credit or debit card. The card 70 may also have a magnetic strip that allows for the number of card presentations to be electronically recorded.

Referring again to FIG. 1, a member would initially access the information on the database by visiting the opening page 20 of the host website. As noted above, the member could execute a search based on a variety of search criteria. For example, the member could begin a search for a restaurant in a particular city by mouse clicking on link 24. Upon activating the link 24, a dialogue box would appear asking the user to specify the city to be searched. Once the city is specified, the search is executed.

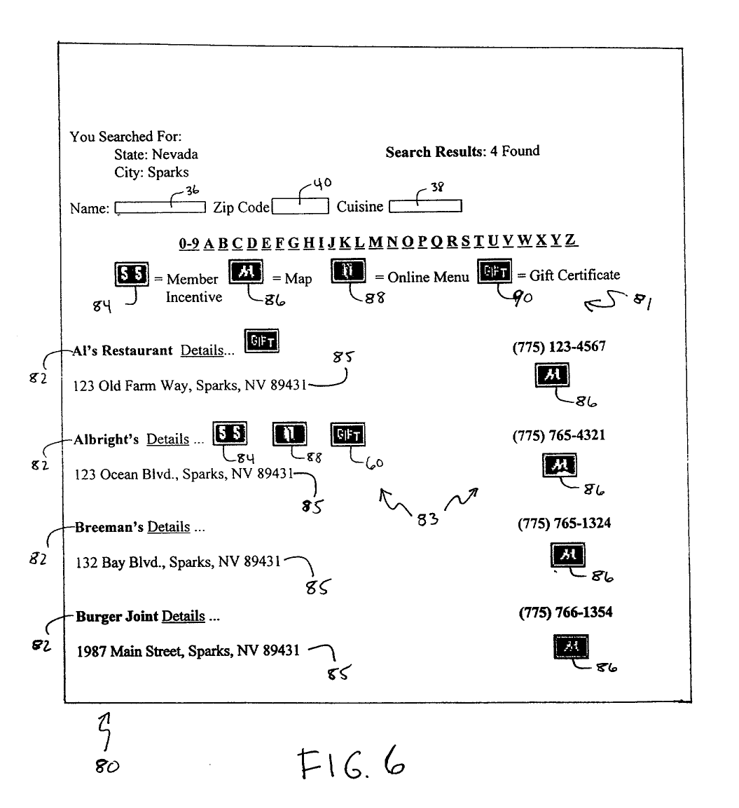

FIG. 6 illustrates a listing page 80 generated by a search of participating restaurants located in Sparks, Nev. The listing page 80 includes the names 82 and addresses 85 of participating restaurants in that area. Next to the participating restaurants is shown a number of icons 83, identified in key 81. The icons 83 shown here are a member incentive icon 84, an online menu icon 88, a gift certificate icon 90, and an online map icon 86.

If a member clicks on icon 90, he will be directed to a page that allows him to purchase a gift certificate to the restaurant whose name the icon is beside. For example, the top participating restaurant 82 on the list in FIG. 6 is “Al's Restaurant.” Next to the restaurant information is the gift certificate icon 90. If the member wishes to create a gift certificate to Al's Restaurant, he would click on that icon 90. Then a window would open that would allow the creation of the gift certificate, wherein amount and the recipient would be specified.

If a member clicks on icon 86, he is linked to an online map directing him to a restaurant's location. A variety of online map programs, that would be apparent to one skilled in the art, would be suitable for this type of link. For example, online maps available through EXPEDIA.COM® (owned by Expedia, Inc. of Bellevue, Wash.) are used in the present embodiment.

Icon 84 will link a member to a member incentive page 92, as seen in FIG. 7. The member incentives page 92 features a member incentive 94 from a particular subscribing restaurant, redeemable upon visiting the subscribing restaurant. For example, if a member were to click on the member incentives icon 84 (FIG. 6) next to “Albright's” (the subscribing restaurant), he would be directed to the member incentives page 92. The member incentives page 92 displays the particular offer 94 from the subscribing restaurant. In FIG. 7, the member incentive 94 is a complimentary appetizer to members who come in between 6:00 p.m. and 9:00 p.m.

Once the member is apprised of the member incentive 94, he or she may then visit the subscribing restaurant that issued the incentive. The subscribing restaurant then redeems the member incentive 94 upon presentation of the membership card 70, and records the total number of times a membership card 70 is presented.

By recording the instances in which a membership card 70 is presented, the subscribing restaurant is able to ascertain how many of its customers were referred through its subscription to the host website database. This information can then be utilized to determine whether expenditures associated with subscribing to the host website are worthwhile. For example, if a subscribing restaurant spends $1000 per year in subscription fees for the host website, but, at year end, records 500 instances in which a membership card was presented, amounting to a total of $7000 in revenues, then the restaurant can utilize this data to determine whether to invest its resources in a similar way the following year.

It is noted that, in order to minimize abuse of the member incentives, it may be desirable to limit the number of times a particular membership card 70 can be redeemed to once a day. Such limitation of use could be accomplished by simply recording the membership account number 74, either electronically or manually.

Variations of the Invention

Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, form, function, manner of operation and use may be made without departing from the principles and concepts set forth herein.

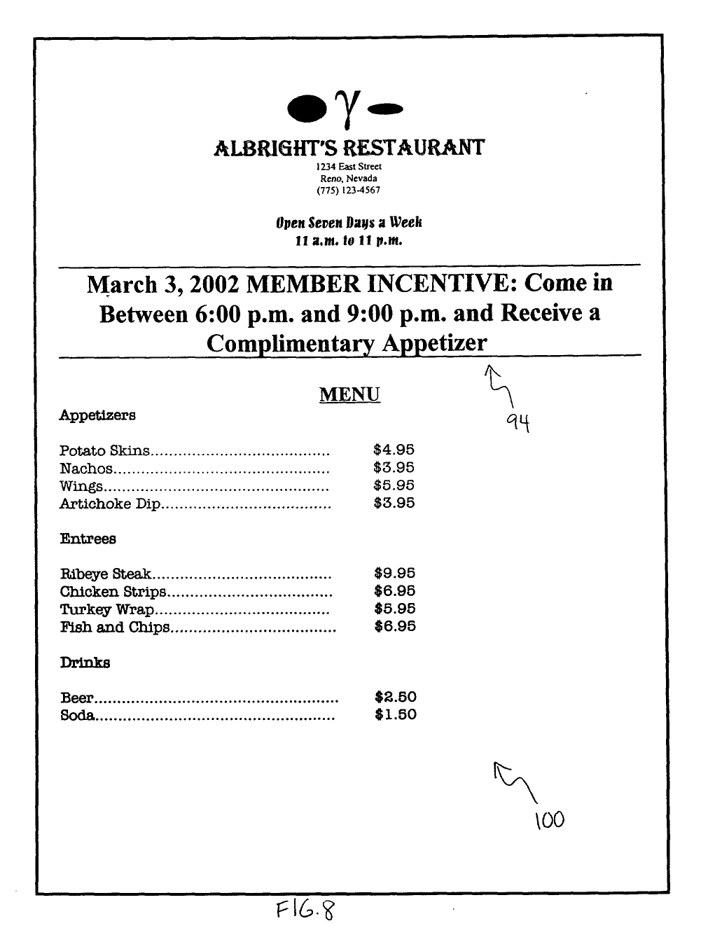

In the embodiment set forth above, the member incentive 94 is shown as occupying its own page 92 (FIG. 7). However, it is noted that the member incentive 94 could also be displayed on the electronic menu 100, as seen in FIG. 8. A member is directed to the menu 100 by clicking on icon 88, as seen in FIG. 6.

It is also noted that the restaurant logo 68 can be uploaded and thereby included in the member incentive page 92 or menu page 100. This is accomplished through techniques known in the art, and may be implemented by activating an electronic button 59 (FIG. 3). As is also apparent from the figures, advertisements 44 and other links 42 may also be included on the opening page 20 of the host website.

It is also noted that, in the present embodiment, the service providers are discussed as restaurants. However, it is noted that numerous other types of service providers could be utilized in the present invention, including, but not limited to, medical service providers, legal service providers and repair service providers.

While specific search strategies are discussed above with respect to FIG. 1 (e.g. citybased searches, cuisine type-based searches, etc.), it is noted that any of these search criteria can be combined. For example, a user could search by cuisine type in a particular location. Combination of search criteria in this manner would be well known to one skilled in the art.

What is claimed is:

1) A method of tracking an individual referred to a service industry by a host website, comprising the steps of:
a) establishing a database, that is accessible through the host website, that includes:
i) an incentive for visiting the service industry; and
ii) optionally, information about the service industry;
b) providing an interface to the service industry that allows the service industry to remotely update the incentives;
c) providing a membership card to the individual;
d) redeeming the incentive when the individual visits the service industry and presents the membership card; and
e) recording each presentation of the membership card, thereby tracking the individuals referred to the service industry by the host website.

2) The method of claim 1, wherein the service industry is a restaurant.

3) The method of claim 1, wherein the incentive is a free item.

4) The method of claim 1, wherein the incentive is a discounted item.

5) The method of claim 1, wherein the service industry remotely updates its incentives through a dialogue box.

6) The method of claim 1, wherein the membership card is incorporated into a credit card.

7) A method of tracking an individual referred to a service industry by a host website, comprising the steps of:
a) establishing a database, that is accessible through the host website, that includes:
i) an incentive for visiting the service industry; and
ii) optionally, information about the service industry;
b) providing a membership card to the individual;
c) redeeming the incentive when the individual visits the service industry and presents the membership card; and
d) recording each presentation of the membership card, thereby tracking the individuals referred to the service industry by the host website.

8) The method of claim 7, further comprising the step of providing an interface to the service industry that allows the service industry to remotely update the incentives.

9) The method of claim 7, wherein the service industry is a restaurant.

10) The method of claim 7, wherein the incentive is a free item.

11) The method of claim 7, wherein the incentive is a discounted item.

12) The method of claim 7, wherein the membership card is incorporated into a credit card.

13) A method of marketing a service industry through a host web site, comprising the steps of:
a) establishing a database, that is accessible through the host website, that includes:
i) an incentive for visiting the service industry; and
ii) optionally, information about the service industry; and
b) providing an interface to the service industry that allows the service industry to remotely update the incentives, responsive to present business circumstances.

14) The method of claim 13, wherein the service industry is a restaurant.

15) The method of claim 13, wherein the incentive is a free item.

16) The method of claim 13, wherein the incentive is a discounted item.

17) The method of claim 13, wherein the service industry remotely updates its incentives through a dialogue box.
